(19) United States
(12) Patent Application Publication
(10) Pub. No.: US 2018/0018573 A1
(43) Pub. Date: Jan. 18, 2018

(54) VECTOR OPERATORS FOR DISTRIBUTIONAL ENTAILMENT

(71) Applicant: Xerox Corporation, Norwalk, CT (US)

(72) Inventors: James Brinton Henderson, Vessy (CH); Diana Nicoleta Popa, Grenoble (FR)

(73) Assignee: Xerox Corporation, Norwalk, CT (US)

(21) Appl. No.: 15/208,020

(22) Filed: Jul. 12, 2016

(51) Int. Cl. G06N 5/04; G06N 99/00

(52) U.S. Cl. CPC G06N 5/046; G06N 5/042; G06N 99/005

(57) ABSTRACT

A system and method for making entailment inferences are disclosed. Entailment inferences are computed between semantic representations of text objects which, for a set of features, indicate whether the feature is known or unknown about the text object. A function of the semantic representations of first and second text objects is computed with an asymmetric vector space operator which differs depending on the entailment relationship.

### BACKGROUND

Aspects of the exemplary embodiment relate to a system and method for prediction of entailment relations based on semantic representations of text sequences, such as words and phrases.

Vector-space representations of semantics are now very popular, because distributional models of semantics allow these representations to effectively capture many forms of semantic similarity, and can be trained on large amounts of unannotated text. However, similarity is of only limited use; in many tasks what we really want is semantic entailment, which is a more powerful asymmetric relation. For example, to produce abstract summaries, we need to ensure that the text entails the summary. Previous work on modeling entailment using vector spaces has generally relied on the same vector operator as similarity, namely the dot product, which is a symmetric operator, and thus these methods have relied on scores computed outside of the vector space to break the symmetry, or supervised learning of the operator itself.

Distributional semantics uses the distributions of words in contexts to induce vector-space embeddings of words that encode their semantic similarity. Two words are predicted to be similar if the dot product between their vectors is high. Two popular examples of such models are the Conditional Bag-of-Words (CBOW) and Skip-Gram models of the Word2Vec software (Mikolov, T., et al., “Efficient estimation of word representations in vector space,” ArXiv:1301.3781, pp. 1-12 (2013), “Mikolov 2013a”; Mikolov, T., et al., “Distributed representations of words and phrases and their compositionality,” NIPS, 26, pp. 3111-3119 (2013), “Mikolov 2013b”). These simple neural network models are very fast, and can be applied to very large corpora of unannotated text. Their induced word embeddings have been shown to be useful for a wide variety of tasks.

Entailment is a more powerful semantic relation than similarity. Similarity can be considered a soft symmetric version of entailment. But distributional semantic models have had difficulty modeling lexical entailment, in part because they are based on the dot product, which is symmetric. The most successful previous work on unsupervised or semi-supervised models of lexical entailment tasks, such as hypernym detection, have either developed several asymmetric measures or used a combination of the similarity score from distributional semantic vectors with these measures. See, for example, Kotlerman, L., et al., “Directional distributional similarity for lexical inference,” Nat. Lang. Eng., 16(4):359-389 (2010), “Kotlerman 2010”; Baroni, M., et al., “Entailment above the word level in distributional semantics,” Proc. 13th Conf. of the European Chapter of the Association for Computational Linguistics (EACL '12), pp. 23-32 (2012), “Baroni 2012”; Lenci, A., et al., “Identifying hypernyms in distributional semantic spaces,” Proc. 1st Joint Conf. on Lexical and Computational Semantics—Volume 1: Proc. Main Conf. and the Shared Task, and Vol. 2: Proc. of the 6th Int'l Workshop on Semantic Evaluation (SemEval '12), pp. 75-79 (2012), “Lenci 2012”; Santus, E., et al., “Chasing hypernyms in vector spaces with entropy,” Proc. 14th Conf. of the European Chapter of the Association for Computational Linguistics (EACL 2014), pp. 38-42 (2014), “Santus 2014”; and Yu, Z., et al., “Learning term embeddings for hypernymy identification,” Proc. 24th Int'l Joint Conf. on Artificial Intelligence (IJCAI 2015), pp. 1390-1397 (2015), “Yu 2015”

Hyponymy detection using supervised, semi-supervised or unsupervised methods is described, for example, in Fu, R., et al., “Learning semantic hierarchies: A continuous vector space approach,” IEEE/ACM Transactions on Audio, Speech, and Language Processing, 23(3):461-471 (2015), “Fu 2015”; Rei, M. et al., “Looking for hyponyms in vector space,” 18th Conf. on Computational Natural Language Learning, pp. 68-77 (2014), “Rei 2014”), Weeds, J., “Learning to distinguish hypernyms and co-hyponyms,” Proc. COLING, pp. 2249-2259 (2014), “Weeds 2014”; Nayak, N., “Learning hypernymy over word embeddings,” CS224d: Deep Learning for Natural Language Processing Technical Report, pp. 1-8 (2015); Vylomova, E., et al., “Take and took, gaggle and goose, book and read: Evaluating the utility of vector differences for lexical relation learning,” arXiv:1509.01692, pp. 1-16 (2015), “Vylomova 2015.”

For example, in Fu 2015 a projection matrix is learnt to project words in clusters to their respective hypernyms in a new space. To detect whether a hyponymy relation holds between two words, the cluster with the closest center to the offset of the two vectors is computed and the corresponding projection applied using a threshold value for decision. The information about hyponymy is thus captured within the matrix parameters, rather than in the vector space itself.

Rei 2014 describes an asymmetric vector space operator for hyponymy which does not require trained parameters. The dimensions of the dot product (normalized to make it a cosine measure) are weighted to put more weight on the larger values in the entailed (hypernym) vector. This unsupervised model of hyponymy, however, is only used to rank candidate hyponyms.

The present system and method provide asymmetric functions which enable hypernym and hyponym relations to be predicted.

### INCORPORATION BY REFERENCE

The following references, the disclosures of which are incorporated herein by reference in their entireties, are mentioned:

U.S. Pub. No. 20110276322, published Nov. 10, 2011, entitled TEXTUAL ENTAILMENT METHOD FOR LINKING TEXT OF AN ABSTRACT TO TEXT IN THE MAIN BODY OF A DOCUMENT, by Agnes Sandor, et al.

U.S. Pub. No. 20150199339, published Jul. 16, 2015, entitled SEMANTIC REFINING OF CROSS-LINGUAL INFORMATION RETRIEVAL RESULTS, by Shachar Mirkin, et al.

### BRIEF DESCRIPTION

In accordance with one aspect of the exemplary embodiment, a method for making an entailment inference includes, with a processor, computing an entailment inference for a first text object with respect to a second text object. This includes computing a function of semantic representations of the first and second text objects with an asymmetric vector space operator. Information based on the inference is output.

In accordance with another aspect of the exemplary embodiment, an entailment system includes a representation generation component which generates semantic representations of text objects using a trained semantic model, each semantic representation comprising a multidimensional vector. An inference component computes an entailment inference for a first text object with respect to a second text object. This includes computing a function of semantic representations of the first and second text objects with an asymmetric vector space operator. An output component outputs information based on the inference. A processor implements the components.

In accordance with another aspect of the exemplary embodiment, a method for making an entailment inference includes storing an asymmetric vector space operator for computing a function of semantic representations of first and second text objects, the asymmetric vector space operator being selected from a forward-inference entailment operator, a backward-inference entailment operator, and a factorized entailment operator. The forward-inference entailment operator predicts whether the first text object, having a semantic representation X, is entailed by the second text object, having a semantic representation Y, as a function of a dot product of X and log Y, or sigmoid functions thereof, where log Y is a vector in which each element is the logₑ of the corresponding element in Y. The backward-inference entailment operator predicts whether the second text object entails the first text object as a function of a dot product of (1−Y) and log(1−X), or sigmoid functions thereof. The factorized entailment operator predicts whether the second text object entails the first text object as a function of a sum, over a set of k dimensions, of a log function of the kth elements of X and Y. With a processor, the selected asymmetric vector space operator is computed to infer at least one of: whether the first text object entails the second text object, whether the second text object entails the first text object, a semantic representation of the second text object, given that an entailment relation exists between the first and second text objects, and a semantic representation of the first text object, given that an entailment relation exists between the first and second text objects. Information based on the inference is output.

### BRIEF DESCRIPTION OF THE DRAWINGS

FIG. 1 is a functional block diagram of a system for modeling entailment in accordance with one aspect of the exemplary embodiment;

FIG. 2 is a flow chart illustrating a method for modeling entailment in accordance with another aspect of the exemplary embodiment; and

FIG. 3 is a plot illustrating learning gradients for Word2Vec, log-odds [symbol] , and unk dup [symbol] interpretation of its vectors.

### DETAILED DESCRIPTION

Logical entailment describes a relation between two text objects, such as words, phrases, or sentences. If the first text object entails the second then this means that if the first is true then the second must also be true.

Distributional semantics can be used to create vector-space representations that capture many forms of semantic similarity, but their relation to semantic entailment has been less clear. A vector-space model which provides a formal foundation for a distributional semantics of entailment is described. Using a mean-field approximation, approximate inference procedures and entailment operators over vectors of probabilities of features being known (versus unknown) are described. This framework can be used to reinterpret an existing distributional-semantic model (Word2Vec) as approximating an entailment-based model of the distributions of words in contexts, thereby predicting lexical entailment relations. In both unsupervised and semi-supervised experiments on hyponymy detection, substantial improvements over previous results are obtained.

Unlike previous vector-space models of entailment, the exemplary framework explicitly models what information is unknown. This is a useful property, because entailment reflects what information is and is not known; a representation y entails a representation x if and only if everything that is known given x is also known for y. Thus, entailment can be modeled in a vector space where each dimension represents something that may be known. As illustrated in Table 1, knowing that a feature f is true always entails knowing that same feature, but never entails knowing that a different feature g is true. Also, knowing that a feature is true always entails not knowing anything (unk), since strictly less information is still entailment, but the reverse is never true. Table 1 also illustrates that knowing that a feature f is false ( [symbol] ) patterns exactly the same way as knowing that an unrelated feature g is true. This illustrates that the relevant dichotomy for entailment is known versus unknown, and not true versus false.

TABLE 1
Pattern of logical entailment between nothing known (unk), two different
features f and g known, and the complement of f ( [symbol] ) known

| [symbol] | unk | f | g | [symbol] |
|---|---|---|---|---|
| unk | 1 | 0 | 0 | 0 |
| f | 1 | 1 | 0 | 0 |
| g | 1 | 0 | 1 | 0 |
| [symbol] | 1 | 0 | 0 | 1 |

To develop a vector-space model of whether features are known or unknown, discrete binary vectors, where 1 means known and 0 means unknown, can be generated. Entailment between these discrete binary vectors can be computed by independently checking each dimension. However to do calculations with distributions over these vectors, it is useful to consider the case where the features are not independent. For example, if feature f has a 50% chance of being true and a 50% chance of being false, the assumption that there is a 25% chance that both f and [symbol] are known may well be incorrect. This simple case of mutual exclusion is just one example of a wide range of constraints between features which the method can incorporate into a semantic model. These constraints mean that the different dimensions of the vector space are not independent, and therefore exact models are not factorized. Because the models are not factorized, exact calculations of entailment and exact inference of vectors are intractable.

Mean-field approximations are a popular approach to efficient inference for intractable models. In a mean-field approximation, distributions over binary vectors are represented using a single probability for each dimension. These vectors of real values are the basis of the exemplary vector space model for entailment.

The exemplary vector-space model provides a formal foundation for a distributional semantics of entailment. This framework is derived from a mean-field approximation to entailment between binary vectors, and includes operators for measuring entailment between vectors, and procedures for inferring vectors in an entailment graph. The framework is validated by using it to reinterpret existing Word2Vec word embedding vectors as approximating an entailment-based model of the distribution of words in contexts. This reinterpretation allows the use of existing word embeddings as an unsupervised model of lexical entailment, successfully predicting hyponymy relations using the proposed entailment operators in both unsupervised and semi-supervised experiments.

It is therefore assumed that text objects (e.g. words, phrases, sentences), can be each represented by a multidimensional feature vector in a vector space, which is a semantic representation of the text object. Each feature of the vector corresponds to an proposition being known/unknown for an object, which may be a binary value {1,0}, when the proposition is known to be true/unknown, or a continuous probability between 0 and 1, which represents a prediction that the proposition is known. For example, given a simple set of features such as (is a physical object, is a digital object, is a color, is a lethal weapon, is a toy), the word gun could be represented by a binary vector (1,0,0,1,0) and the word toy could be represented by a binary vector (1,0,0,0,1). Given the text object toy gun, its semantic representation should indicate that it is entailed by toy rather than gun, since toy gun is a hyponym of toy. Then, the sentence John played with a toy will be more likely to be predicted to entail John played with a toy gun.

Logical entailment between vectors is computed herein with asymmetric vector operations: a backward-inference entailment operator, denoted [symbol] , and a forward-inference entailment operator, denoted [symbol] . A factorized entailment operator, denoted [symbol] , may alternatively be used.

These operators are computed with asymmetric functions. In particular:

The forward-inference entailment operator can be used to predict whether a first text object, having a feature vector X is entailed by a second text object having a feature vector Y:

X [symbol] Y=X·log Y (1)

where · represents the dot product and log Y is a vector in which each element is the logₑ of the corresponding element in Y.

This can be parameterized as:

X [symbol] Y≡ΣX·log σY

where σ represents the sigmoid function.

The backward-inference entailment operator can be used to predict whether a second text object having a feature vector Y entails a first text object, having feature vector X:

Y [symbol] X=(1−Y)·log(1−X) (2)

This can be parameterized as:

Y [symbol] X≡Σ(−Y)·log σ(−X).

Here 1−Y is the complement of Y, computed by subtracting each element of the vector Y from 1. The backward operator thus uses the probabilities that the bits of a respective vector are not known, whereas the forward vector uses the probabilities that the bits of the vector are known.

The factorized entailment operator can be used to predict whether an entailment relationship exists from the text object having a feature vector Y to the text object having a feature vector X:

$$Y X = {\sum }_{k} log ( 1 - ( 1 - {Y}_{k} ) {X}_{k} ) \qquad ( 3 )$$

where each k is a dimension in the vector space.

This can be parameterized as:

Y [symbol] EΣₖ log(1−σ(−Yₖ)σ(Xₖ))

Thus for example, for two text objects X and Y with representations (0.5, 0.1, 0.2) and (0.4, 0.2, 0.1), then

X [symbol] Y=(0.5, 0.1, 0.2)·log e(0.4, 0.2, 0.1)=(0.5, 0.1, 0.2)·(−0.916, −1.609, −2.302)=−0.458−0.161−0.460=−1.079

Suppose the threshold score is −1.5, then it could be predicted that X is entailed by Y.

Similarly,

$$\begin{matrix}Y X = ( 1 - 0.4 , 1 - 0.2 , 1 - 0.1 ) \cdot {log}_{e} ( 1 - 0.5 , 1 - 0.1 , 1 - ( \\ = ( 0.6 , 0.8 , 0.9 ) \cdot {log}_{e} ( 0.5 , 0.9 , 0.8 ) \\ = ( 0.6 , 0.8 , 0.9 ) \cdot ( - 2.303 , - 0.105 , - 0.223 ) \\ = - 1.382 - 0.084 - 0.201 = - 1.667\end{matrix}$$

Suppose the threshold score is −1.5, then it could be predicted that Y does not entail X.

In the following, application of these operators to inferring a semantic representation of a text object that entails, or is entailed by, a text object with a given semantic representation is described. An extension to entailment graphs for multi-word text objects is described. The operators may also be used for clustering text objects, as described below.

As an example of semantic representations, these operations can be used with object representations generated with the Word2Vec CBOW model or Skip-Gram model to facilitate capturing evidence about entailment that is present in the distribution of words in context.

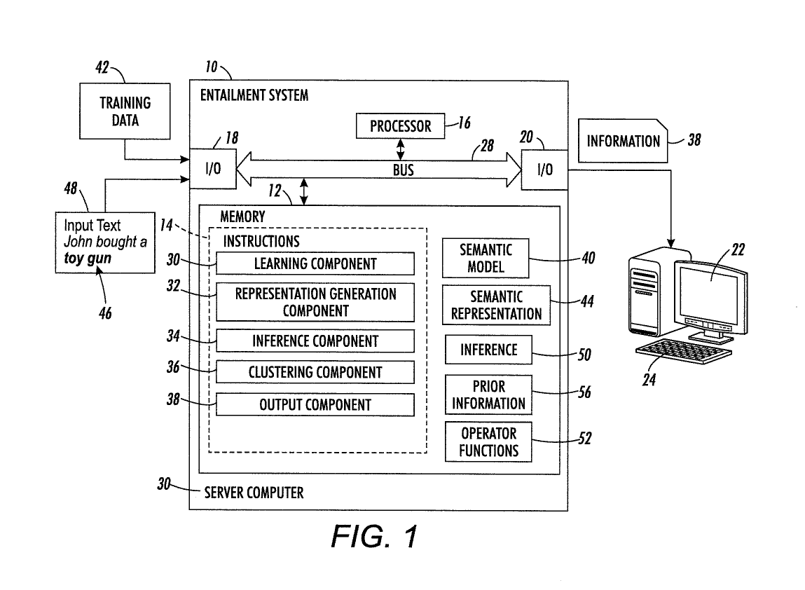

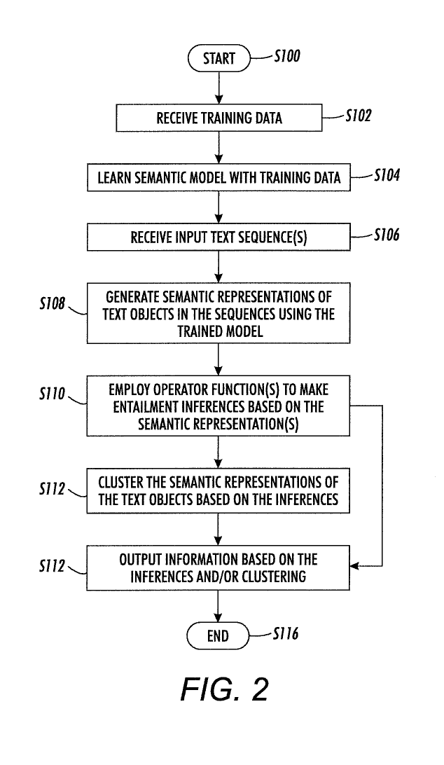

With reference to FIG. 1, a functional block diagram of a computer-implemented system 10 for predicting entailment relations based on semantic representations of text sequences is shown. The illustrated computer system 10 includes memory 12 which stores software instructions 14 for performing the method illustrated in FIG. 2 and a processor 16 in communication with the memory for executing the instructions. The system 10 also includes one or more input/output (I/O) devices, such as a network interface 18 and a user input output interface 20. The I/O interface 20 may communicate with one or more of a display 22, for displaying information to users, speakers, and a user input device 24, such as a keyboard or touch or writable screen, and/or a cursor control device, such as mouse, trackball, or the like, for inputting text and for communicating user input information and command selections to the processor device 16. The various hardware components 12, 16, 18, 20 of the system 10 may all be connected by a data/control bus 28.

The computer system 10 may include one or more computing devices 30, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data.

The network interface 18 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 30.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The exemplary instructions 14 include a learning component 30, a representation generation component 32, an inference component 34, optionally, a clustering component 36, and an output component 38.

Briefly, the learning component 30 trains a semantic model 40 based on training data 42. The training data may be a collection of unlabeled sentences in an unsupervised case. In a semi-supervised case, the training data 42 includes input vectors and the trained model 40 maps the input vectors to a vector space in which the embedded vectors 44 are better predictors of entailment.

The representation generation component 32 uses the model 40, when trained, to generate one or more semantic representations 44 of text objects 46 in input text sequences 48.

The inference component 34 makes entailment inferences 50 based on the semantic representation(s) 44 using one or more operator functions 52 employing the backward-inference entailment operator or forward inference operator. The inferences may also be based on prior information about variables in the semantic representations 44. This may be expressed as a set of constraints, such as: if the feature is a toy is true then the feature is a lethal weapon is not true, which reduces the probability that both these features will be assigned a high probability of being true.

Optionally, the clustering component 36 clusters semantic representations of text objects based on the inferences.

The output component 38 outputs information 54 based on the inferences and/or clustering.

FIG. 2 illustrates a method of inferring entailment relations between text objects. The method begins at S100.

At S102, training data 42 may be received by the system and temporarily stored in memory 12.

At S104, a semantic model 40 is learned, based on training data 42, for generating semantic representations 44. The trained model 40 may be stored in memory 12. If a model 40 is already available, steps S102 and S104 may be omitted.

At S106, one or more in input text sequences 48 is/are received and may be stored in memory 12.

At S108, semantic representations 44 of text objects 46 in the text sequences is/are generated by the representation generation component 32, using the trained model 40.

At S110, one or more operator functions 52 employing the backward-inference entailment operator or forward inference operator are used to make entailment inferences based on the semantic representation(s) 44, using the inference component 34.

At S112, the semantic representations of text objects may be clustered based on the inferences, by the clustering component 36.

At S114, information 54 based on the inferences and/or clustering is output, by the output component 38.

The method ends at S116.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive or independent disks (RAID) or other network server storage that is indirectly accessed by the computer 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details of the system and method will now be described.

### Vector Operators

The method makes use of asymmetric vector space operators [symbol] and [symbol] , which are particularly suited to modeling entailment within a single vector space.

In one embodiment, one word is predicted to be a hypernym of another based on [symbol] or [symbol] operator functions 52 of their semantic representations 44 (e.g., their Word2Vec word embeddings). For example, if a score computed with one of the operator functions 52 exceeds a threshold, the respective forward or backward entailment is inferred.

In another embodiment, a semi-supervised model 40 of hyponymy is learnt by learning a mapping from input semantic representations 42, such as Word2Vec word embeddings to a new vector space, such that the forward operator [symbol] , applied in that new space, is a good predictor of hyponymy in that new vector space. Such models and their induced word embeddings 44 have applications in the wide variety of tasks that benefit from robust entailment prediction. For example, producing abstract summaries of text requires that the summary is entailed by the text. Such summaries are useful for large-scale opinion summarization, for example where the aim is to label a cluster of opinions with an abstract statement which all the opinions imply. This potential is illustrated with a clustering algorithm for words that labels clusters with abstract words, i.e., with semantic representations that do not directly correspond to real words. This approach to distributional entailment by inducing a vector space, rather than training a classifier (a scoring function), as used in existing methods shows good results.

### Generating Feature Vectors

The training data may include raw text and/or hyponymy data (information about whether one word entails another), which can be used to learn a model 40 that outputs feature vectors for text objects, such as words, that are used for predicting entailment relations between text objects of a text string.

Raw text can be used to learn a model 40 that outputs feature vectors by modelling the fact that texts are internally consistent and often redundant. This means that there exists a vector of features which includes all the features entailed by the text and which is consistent with general constraints on compatible sets of features. The vector operators and inference procedures above can be used to model this vector. Such a vector will most often not exist for a text consisting of a random collection of words or sentences, because such random texts are almost never consistent or redundant. By training the model to distinguish between observed texts and random texts, vectors of features for words or texts can be learned.

Examples of other methods for generating feature vectors are described in Baroni 2011, Kotlerman 2010, Baroni 2012, Lenci 2012, Santus 2014, and Yu 2015, mentioned above.

### Modeling Entailment in a Vector Space

In one embodiment, a mean-field approximation to logical entailment of vectors is employed, which provides a probabilistic model of entailment in continuous vector spaces.

Entailment as a logical relation [symbol] can be formalized by interpreting 1 as known and 0 as unknown, i.e., (1 [symbol] 0), (1 [symbol] 1) and (0 [symbol] 0) are valid, but (0 [symbol] 1). y entails x if all the things known about x are also known about y, but does not require that all things known about y are also known about x. A vector of bits (features) y (representing the meaning of a word or word sequence) entails another vector of bits x (representing the meaning of a word or word sequence) if and only if, for all positions k in the vectors, yₖ [symbol] xₖ. In the vector, a 1 indicates the respective feature is true, a 0 indicates the feature is unknown.

Equations (1) and (2) above can be obtained as follows:

The discrete function of binary values can be generalized to continuous values as:

$$( y ⇒ x ) = {\prod }_{k} ( 1 - ( 1 - {y}_{k} ) {x}_{k} ) \qquad ( 4 )$$

i.e., as the product of each value of (1−(1−yₖ)xₖ) for each element of the vectors from 1 to k. This discrete entailment relation (y [symbol] x) can be defined with the binary formula:

$$P ( ( y ⇒ x ) \vert x , y ) = {\prod }_{k} ( 1 - ( 1 - {y}_{k} ) {x}_{k} ) \qquad ( 5 )$$

Given prior probability distributions over these vectors, the exact joint probability and marginal probabilities for an entailment relation can be written as:

$$P ( x , y , ( y ⇒ x ) ) = P ( x ) P ( y ) {\prod }_{k} ( 1 - ( 1 - {y}_{k} ) {x}_{k} ) \qquad ( 6 )$$

which gives:

$$P ( y ⇒ x ) = {E}_{P ( x )} {E}_{P ( y )} {\prod }_{k} ( 1 - ( 1 - {y}_{k} ) {x}_{k} ) \qquad ( 7 )$$

It cannot be assumed that the priors P(x) and P(y) are factorized, because there are many potential correlations between features and therefore it may not be reasonable to assume that the features are independent. Even just representing both a feature f and its negation [symbol] involves two different dimensions k and k′ in the vector space, because 0 represents unknown and not false. Given valid feature vectors, calculating entailment can consider these two dimensions separately, but to reason with distributions over vectors, the prior P(x) should be able to enforce the constraint that xₖ and xₖ′ are mutually exclusive. In general, such correlations and anti-correlations exist between many semantic features, which makes inference and calculating the probability of entailment intractable.

To allow for efficient inference in such a model, a mean-field approximation is employed. This, in effect, assumes that the posterior distribution over vectors is factorized, but in practice this is a much weaker assumption than assuming the prior is factorized. The posterior distribution has less uncertainty and therefore is influenced less by non-factorized prior constraints. By assuming a factorized posterior, distributions over feature vectors can be represented with simple vectors of probabilities of individual features (or as below, with their log-odds). These real-valued vectors are the basis of the exemplary vector-space model of entailment.

### A Mean-Field Approximation

The probability of entailment can be modeled using a mean-field approximation. First of all, this provides a concise description of the posterior P(x| . . . ) is given as a vector of continuous values Q(x=1), where Q(x=1)ₖ=Q(xₖ=1)≈E_{P(x| . . . )}xₖ=P(xₖ=1| . . . ) (i.e., the marginal probabilities of each bit). Second, as is shown below, this provides efficient methods for inferring the vectors in a model.

First, consider the simple case where the aim is to approximate the posterior distribution P(x,y|y [symbol] x). In a mean-field approximation, the goal is to find a factorized distribution Q(x,y) which minimizes the Kullback-Leibler (KL)-divergence D_{KL}(Q(x,y)∥P(x,y|y [symbol] x)) with the true distribution P(x,y|y [symbol] x).

$$\begin{matrix}L = {D}_{KL} ( Q ( x , y ) \vert \vert P ( x , y \vert ( y ⇒ x ) ) ) ∝ {\sum }_{x} Q ( x ) log \frac{Q ( x , y )}{P ( x , y , ( y ⇒ x ) )} \\ = {\sum }_{xy} Q ( x , y ) log Q ( x , y ) - {\sum }_{xy} Q ( x , y ) log P ( x , y , ( y ⇒ x ) ) \\ = {E}_{Q ( x , y )} log ( \begin{matrix}{\prod }_{k} Q ( {x}_{k} ) {\prod }_{k} Q ( {y}_{k} ) ) - {E}_{Q ( x , y )} log ( P ( x ) P ( y ) + \\ {\prod }_{k} ( 1 - ( 1 - {y}_{k} ) {x}_{k} )\end{matrix} ) \\ = {\sum }_{k} {E}_{Q ( {x}_{k} )} log Q ( {x}_{k} ) + {\sum }_{k} {E}_{Q ( {y}_{k} )} log Q ( {y}_{k} ) - \\ {E}_{Q ( x )} log P ( x ) - {E}_{Q ( y )} log P ( y ) - {\sum }_{k} {E}_{Q ( {x}_{k} )} {E}_{Q ( {y}_{k} )} log ( 1 - ( 1 - {y}_{k} ) {x}_{k} )\end{matrix} \qquad ( 8 )$$

In Eqn (8), the first two terms are the negative entropy of Q, −H(Q), which acts as a maximum entropy regularizer, the final term enforces the entailment constraint, and the middle two terms represent the prior for x and y. One approach (generalized further below) to the prior terms −E_{Q(x)}log P(x) is to bound them by assuming P(x) is a function in the exponential family (and equivalently for y), giving:

$$\begin{matrix}{E}_{Q ( x )} log P ( x ) = {E}_{Q ( x )} log \frac{exp ( {\sum }_{k} {θ}_{k}^{x} {x}_{k} )}{{Z}_{θ}} \\ = {\sum }_{k} {E}_{Q ( {x}_{k} )} {θ}_{k}^{x} {x}_{k} - log {Z}_{θ}\end{matrix} \qquad ( 9 )$$

where θₖ^{x} is a set of constraints on xₖ. In practice, log Z_{θ} is not relevant in inference problems and can be ignored.

As is often the case with mean-field approximations, inference of Q(x) and Q(y) cannot be performed efficiently with this exact objective L, because of the nonlinear interdependence between xₖ and yₖ. Thus, two approximations to L are introduced, one for use in inferring Q(x) given Q(y) (forward inference), and one for the reverse inference problem (backward inference). In both cases, the approximation can be performed with an application of Jensen's inequality to the log function, which gives an upper bound on L, as is standard practice in mean-field approximations.

For forward inference:

L≦−H(Q)−Q(xₖ=1)θₖ^{x}−E_{Q(y}_{ₖ₎}θₖ^{y}yₖ−Q(xₖ=1)log Q(yₖ=1)) (10)

Optimizing this for Q(xₖ=1):

Q(xₖ=1)=σ(θₖ^{x}+log Q(yₖ=1)) (11)

where σ( ) is the sigmoid function which converts values to the range of 0-1. The sigmoid function arises from the entropy regularizer, making this a specific form of maximum entropy model.

For backward inference:

L≦−H(Q)−E_{Q(x}_{ₖ}₎θₖ^{x}xₖ−Q(yₖ=1)θₖ^{y}−(1−Q(yₖ=1))log(1−Q(xₖ=1))) (12)

Optimizing for Q(yₖ=1) gives:

Q(yₖ=1)=σ(θₖ^{y}−log(1−Q(xₖ=1))) (13)

Note that in equations (9) and (11) the final terms, Q(xₖ=1)log Q(yₖ=1) and (1−Q(yₖ=1))log(1−Q(xₖ=1)) respectively, are approximations to the log-probability of the entailment. Applying these mean-field approximations for inference, the two vector-space operators [symbol] and [symbol] , which approximate the log-probability of entailment log P(y [symbol] x), can be defined in the same way to be these same approximations.

$$\begin{matrix}log Q ( y ⇒ x ) = log ( {E}_{Q ( x )} {E}_{Q ( y )} {\prod }_{k} ( 1 - ( 1 - {y}_{k} ) {x}_{k} ) ) \\ = {\sum }_{k} log ( {E}_{Q ( {x}_{k} )} {E}_{Q ( {y}_{k} )} ( 1 - ( 1 - {y}_{k} ) {x}_{k} ) ) \\ \approx {\sum }_{k} {E}_{Q ( {x}_{k} )} log ( {E}_{Q ( {y}_{k} )} ( 1 - ( 1 - {y}_{k} ) {x}_{k} ) ) \\ = {\sum }_{k} Q ( {x}_{k} = 1 ) log Q ( {y}_{k} = 1 ) \\ = Q ( y = 1 ) dQ ( x = 1 ) = Q ( x = 1 ) \cdot log Q ( y = 1 ) \\ = Q ( x = 1 ) \cdot log Q ( y = 1 ) ≡ X Y\end{matrix}$$

$$and$$

$$\begin{matrix}log Q ( y ⇒ x ) = {\sum }_{k} log ( {E}_{Q ( {x}_{k} )} {E}_{Q ( {y}_{k} )} ( 1 - ( 1 - {y}_{k} ) {x}_{k} ) ) \\ \approx {\sum }_{k} {E}_{Q ( {y}_{k} )} log ( {E}_{Q ( {x}_{k} )} ( 1 - ( 1 - {y}_{k} ) {x}_{k} ) ) \\ = {\sum }_{k} ( 1 - Q ( {y}_{k} = 1 ) ) log ( 1 - Q ( {x}_{k} = 1 ) ) \\ = Q ( y = 1 ) Q ( x = 1 ) \\ = ( 1 - Q ( y = 1 ) ) \cdot log ( 1 - Q ( x = 1 ) ) ) ≡ Y X\end{matrix}$$

Each vector's distribution is thus represented as a vector of independent probabilities X=Q(x=1), Y=Q(y=1).

Then two operators which approximate log P(y [symbol] x), can then be defined:

Forward-inference entailment operator:

X [symbol] Y=X·log Y

X [symbol] Y≡σ(X)·log σ(Y) (1)

Backward-inference entailment operator:

Y [symbol] X=(1−Y)·log(1−X) (2),

or parameterized as:

Y [symbol] X≡σ(−Y)·log σ(−X)

Note that the probability of entailment given in equation (1) becomes factorized when replacing P with Q. A third vector-space operator, [symbol] , is defined to be this factorized approximation, as shown in Eqn. (14):

Y [symbol] X≡Σₖ log(1−σ(−Yₖ)σ(Xₖ)) (14)

Using these approximations, inference can be performed, given (y [symbol] x) with:

X=σ(θ^{x}+log Y) (15)

and

Y=σ(θ^{y}+−log(1−X)) (16)

where σ represents the sigmoid function which outputs a value between 0 and 1, and θ^{x} and θ^{y} are constraint vectors which represent the prior information about x and y, i.e., information about likely y and x in general.

Thus, for example, in Eqn. (15), vector Y is known and the aim is to infer the optimal vector X that satisfies the entailment relationship that Y entails X. In Eqn. (16) X is known and the aim is to predict Y.

The constraint vectors θ^{x} and θ^{y} each include a value for each of the features (elements) in the respective vectors X and Y. The constraint vectors θ^{x} and θ^{y} are generated based on prior information 56. The prior information may be in the form of constraints which limit the independence of features. As will be appreciated, some features may be mutually exclusive or highly unlikely for both to be true. As an example, if one feature is for the proposition is hot and another is for the proposition is cold, then the optimal predicted vector should not include high probabilities of being true for both these features. Similarly, in the case of inferring a vector for toy gun, given that it entails toy, a constraint may be that toy not a lethal weapon, which is propagated to the meaning of toy gun, such that it is not predicted to be a lethal weapon.

These constraints 56 may be stored in the form of a respective correlation matrix such that where it is known (or predicted) that features i and j cannot both be on (true) at the same time, the corresponding element of the matrix may be set to a low, e.g., negative value. In contrast, other features may be highly correlated, so in this case, the element in the matrix corresponding to features i and j will be set to a higher (e.g., positive) value. The constraint vector θ^{x} is computed such that, when added to log Y, makes it less probable that the inferred vector X output by the model 40 will have high probabilities for both of two negatively correlated features and/or more probable that positively correlated features will have similar probabilities. Similarly, θ^{y} is adjusted such that when added to −log(1−X), makes it less probable that the inferred vector Y output by the model 40 will have high probabilities for both of two negatively correlated features and/or more probable that positively correlated features will have similar probabilities. In general many or most of the features in θ^{x} and θ^{y} may be 0, i.e., do not affect the corresponding feature in the output vector.

The optimization of the inferred vector (e.g., Y) may proceed in a sequence of iterations in which Y is first computed ignoring θ^{y}. Then, the constraints which are violated by this vector are identified by comparing the output vector Y with the matrix of constraints and identifying those features for which the constraints are the most violated. Then θ^{y} is computed/modified to attempt to reduce the extent of the constraint violations, e.g., by lowering the weight for one of a pair of negatively correlated features relative to that of the other feature in the pair and/or by adjusting the weights of a pair of positively correlated features. X is then recomputed using the new θ^{y}. The constraints violated are reevaluated and, if appropriate, θ^{y} is modified and Y recomputed. This may be repeated one or more times until no further improvements in constraint violations are achieved or until some other stopping point is reached.

Sometimes it is more convenient to parametrize the vectors by their log-odds instead of by their probabilities, in which case the entailment operators can be written as:

Forward-inference log-odds entailment operator:

X [symbol] Y=σ(X)·log σ(Y) (17)

Backward-inference log-odds entailment operator:

$$Y X = σ ( - Y ) \cdot log σ ( - X ) , \\ where X = log \frac{Q ( x = 1 )}{Q ( x = 0 )} = {σ}^{- 1} ( Q ( x = 1 ) ) . \qquad ( 18 )$$

### Inference in Entailment Graphs

In some cases, it may be desirable to perform inference in a graph of entailments between variables rather than performing inference for one entailment at a time. For example a vector which represents the meaning of toy gun may be inferred, given an entailment relation between toy gun and toy and between toy gun and gun. The exemplary mean-field approximation method can be generalized to inference over such entailment graphs.

To represent the prior information 56 about variables, such as information from observations other than the entailment graph, a prior P(x) is assumed over all the variables xᵢ. The prior is not necessarily factorized, but it is assumed that the posterior given the entailment relations can be approximated as factorized. This is equivalent to assuming that the prior P(x) is itself a graphical model which can be approximated with a mean-field approximation. In the following, this more general case is described, but in the examples below, a uniform factorized prior is assumed.

Given a set of variables xᵢ each representing a vector of binary variables xᵢₖ, a set of entailment relations r={i,j|(xᵢ [symbol] xⱼ)}, and a set of negated entailment relations r̅={i,j|(xᵢ [symbol] xⱼ)}, the joint probability can be expressed as:

$$P ( x , r , \overline{r} ) = \frac{1}{Z} P ( x ) {\prod }_{i} ( \begin{matrix}( {\prod }_{j \text{:} r ( i , j )} {\prod }_{k} P ( {x}_{ik} ⇒ {x}_{jk} \vert {x}_{ik} , {x}_{jk} ) \\ ( {\prod }_{j \text{:} \overline{r} ( i , j )} ( 1 - {\prod }_{k} P ( {x}_{ik} ) ⇒ {x}_{jk} \vert {x}_{ik} , {x}_{jk} )\end{matrix} ) \qquad ( 19 )$$

where x is the set of vectors, which can be represented as nodes in the graph, r is the set of entailment relations, which can be represented by directed edges of the graph, and r̅ the set of relations that should not apply, Z is a normalizing factor. The first set of probabilities is for the entailment relations that hold and the second set is for the entailment relations that do not hold (if known). These can each be approximated using inference operators as described above.

The aim is to find a factorized distribution Q that minimizes D_{KL}(Q(x)∥P(x|r,r̅)), which is equivalent to optimizing (minimizing) Q(X) w.r.t. P(x, r, r̅).

$$\begin{matrix}L = {D}_{KL} ( Q ( x ) \vert \vert P ( x \vert r , \overline{r} ) ) ∝ {\sum }_{x} Q ( x ) log \frac{Q ( x )}{P ( x , r , \overline{r} )} \\ = {\sum }_{x} Q ( x ) log Q ( x ) - {\sum }_{x} Q ( x ) log P ( x , r , \overline{r} ) \\ = ( {\sum }_{i} {\sum }_{k} {E}_{Q ( {x}_{ik} )} log Q ( {x}_{ik} ) ) + log Z - {E}_{Q ( x )} log P ( x ) - \\ {\sum }_{i} {\sum }_{j : r ( i , j )} {\sum }_{k} {E}_{Q ( {x}_{ik} )} {E}_{Q ( {x}_{jk} )} log ( 1 - ( 1 - {x}_{ik} ) {x}_{jk} ) - \\ {\sum }_{i} {\sum }_{j \text{:} r ( i , j )} {E}_{Q ( {x}_{i} )} {E}_{Q ( {x}_{j} )} log ( 1 - {\prod }_{k} ( 1 - ( 1 - {x}_{ik} ) {x}_{jk} ) ) )\end{matrix} \qquad ( 20 )$$

Note that log Z is independent of Q, so it is dropped in the following.

L may be approximated for use in the inference of xᵢₖ as follows, where “ . . . ” refers to all terms that do not involve xᵢₖ in any way, and Xᵢₖ=Q(xᵢₖ=1).

$$L \leq … + {E}_{Q ( {x}_{ik} )} log Q ( {x}_{ik} ) - {E}_{Q ( {x}_{ik} )} log {E}_{Q ( {x}_{{i}^{′} \neq i} )} {E}_{Q ( {x}_{{ik}^{′} \neq k} )} P ( x ) - {\sum }_{j : r ( i , j )} {E}_{Q ( {x}_{ik} )} log {E}_{Q ( {x}_{jk} )} ( 1 - ( 1 - {x}_{ik} ) {x}_{jk} ) - {\sum }_{j : \overline{r} ( i , j )} {E}_{Q ( {x}_{ik} )} log {E}_{Q ( {x}_{{ik}^{′} \neq k} )} {E}_{Q ( {x}_{j} )} ( 1 - {\prod }_{k} ( 1 - ( 1 - {x}_{ik} ) {x}_{jk} ) ) - {\sum }_{j : r ( j , i )} {E}_{Q ( {x}_{ik} )} log {E}_{Q ( {x}_{jk} )} ( 1 - ( 1 - {x}_{jk} ) {x}_{ik} ) - {\sum }_{j : \overline{r} ( j , i )} {E}_{Q ( {x}_{ik} )} log {E}_{Q ( {x}_{{ik}^{′} \neq k} )} {E}_{Q ( {x}_{j} )} ( 1 - {\prod }_{k} ( 1 - ( 1 - {x}_{jk} ) {x}_{ik} ) ) \leq … - log ( 1 - {E}_{Q ( {x}_{{i}^{′} \neq i} )} {E}_{Q ( {x}_{{ik}^{′} \neq k} )} P ( {x}_{\overline{i} k} , {x}_{ik} = 1 ) ) + {E}_{Q ( {x}_{ik} )} log Q ( {x}_{ik} ) - {E}_{Q ( {x}_{ik} )} {θ}_{ik} ( {x}_{\overline{i} k} ) {x}_{ik} - {\sum }_{j : r ( i , j )} {E}_{Q ( {x}_{ik} )} log ( 1 - ( 1 - {x}_{ik} ) {E}_{Q ( {x}_{jk} )} {x}_{jk} ) - {\sum }_{j : \overline{r} ( i , j )} {E}_{Q ( {x}_{ik} )} log ( 1 - {C}_{ijk} ( 1 - ( 1 - {x}_{ik} ) {E}_{Q ( {x}_{jk} )} {x}_{jk} ) ) - {\sum }_{j : r ( j , i )} {E}_{Q ( {x}_{ik} )} log ( 1 - ( 1 - {E}_{Q ( {x}_{jk} )} {x}_{jk} ) {x}_{ik} ) - {\sum }_{j : \overline{r} ( j , i )} {E}_{Q ( {x}_{ik} )} log ( 1 - {C}_{jik} ( 1 - ( 1 - {E}_{Q ( {x}_{jk} )} {x}_{jk} ) {x}_{ik} ) ) = … + {X}_{ik} log {X}_{ik} + ( 1 - {X}_{ik} ) log ( 1 - {X}_{ik} ) - {X}_{ik} {θ}_{ik} ( {x}_{\overline{i} k} ) - {\sum }_{j : r ( i , j )} ( 1 - {X}_{ik} ) log ( 1 - {X}_{jk} ) - {\sum }_{j : \overline{r} ( i , j )} ( {X}_{ik} log ( 1 - {C}_{ijk} ) - ( 1 - {X}_{ik} ) log ( 1 - {C}_{ijk} ( 1 - {X}_{jk} ) ) ) - {\sum }_{j : r ( j , i )} {X}_{ik} log {X}_{jk} - {\sum }_{j : \overline{r} ( j , i )} ( {X}_{ik} log ( 1 - {C}_{jik} {X}_{jk} ) - ( 1 - {X}_{ik} ) log ( 1 - {C}_{jik} ) ) = {\tilde{L}}_{ik} \\ where \text{:} x = {x}_{\overline{i} k} , {x}_{ik} , \\ {θ}_{ik} ( {x}_{ik} ) \leq log \frac{{E}_{Q ( {x}_{{i}^{′} \neq i} )} {E}_{Q ( {x}_{{ik}^{′} \neq k} )} P ( {x}_{\overline{i} k} , {x}_{ik} = 1 )}{1 - {E}_{Q ( {x}_{{i}^{′} \neq i} )} {E}_{Q ( {x}_{{ik}^{′} \neq k} )} P ( {x}_{\overline{i} k} , {x}_{ik} = 1 )} , \\ and {C}_{ijk} \geq {\prod }_{{k}^{′} \neq k} ( 1 - ( 1 - {E}_{Q ( {x}_{{ik}^{′}} )} {x}_{{ik}^{′}} ) {E}_{Q ( {x}_{{jk}^{′}} )} {x}_{{jk}^{′}} ) . \\ ( {C}_{ijk} \geq {\prod }_{{k}^{′} \neq k} ( 1 - σ ( - {X}_{{ik}^{′}} ) σ ( {X}_{{jk}^{′}} ) ) \qquad ( 21 )$$

Here, for the representation of prior information, θᵢₖ(x_{īk}) is used to stand in for the log-odds terms contributed by including the prior P(x) in the mean-field approximation.

$${θ}_{ik} ( {X}_{\overline{i} k} ) \leq log \frac{{E}_{Q ( {x}_{\overline{i} k} )} P ( {x}_{\overline{i} k} , {x}_{ik} = 1 )}{1 - {E}_{Q ( {x}_{\overline{i} k} )} P ( {x}_{\overline{i} k} , {x}_{ik} = 1 )}$$

where x_{īk} is the set of all x_{i′k′} such that either i′≠i or k′≠k. These terms can be thought of as the log-odds terms that would be contributed to the loss function including the prior's graphical model in the mean-field approximation.

Then, the optimal Xᵢₖ can be inferred as:

$${X}_{ik} = {θ}_{ik} ( {X}_{\overline{i} k} ) + {\sum }_{j : r ( i , j )} - log σ ( - {X}_{jk} ) + {\sum }_{j : r ( j , i )} log σ ( {X}_{jk} ) + {\sum }_{j : \overline{r} ( j , i )} log σ \frac{1 - {C}_{ijk} σ ( {X}_{jk} )}{1 - {C}_{ijk}} + {\sum }_{j : \overline{r} ( i , j )} - log \frac{1 - {C}_{ijk} σ ( - {X}_{jk} )}{1 - {C}_{ijk}} \qquad ( 22 )$$

Since Cᵢⱼₖ is likely to be small for all xᵢ [symbol] xⱼ, these terms can be further simplified with log(1−Cᵢⱼₖ)≧−c and log(1−Cᵢⱼₖx)≧−cx, if desired.

Now the optimal Xᵢₖ can be inferred as follows:

$$\frac{\partial {\tilde{L}}_{ik}}{\partial {X}_{ik}} = 0 = log \frac{{X}_{ik}}{1 - {X}_{ik}} - {θ}_{ik} ( {X}_{\overline{i} k} ) + {\sum }_{j : r ( i , j )} log ( 1 - {X}_{jk} ) + {\sum }_{j : \overline{r} ( i , j )} log \frac{1 - {C}_{ijk} ( 1 - {X}_{jk} )}{1 - {C}_{ijk}} - {\sum }_{j : r ( j , i )} log {X}_{jk} + {\sum }_{j : \overline{r} ( j , i )} log \frac{1 - {C}_{ijk}}{1 - {C}_{ijk} {X}_{jk}} \\ {X}_{ik} = σ ( {θ}_{ik} ( {X}_{\overline{i} k} ) + {\sum }_{j : r ( i , j )} - log ( 1 - {X}_{jk} ) - {\sum }_{j : \overline{r} ( i , j )} log \frac{1 - {C}_{ijk} ( 1 - {X}_{jk} )}{1 - {C}_{ijk}} + {\sum }_{j : r ( j , i )} log {X}_{jk} - {\sum }_{j : \overline{r} ( j , i )} log \frac{1 - {C}_{ijk}}{1 - {C}_{ijk} {X}_{jk}} ) \qquad ( 23 )$$

Eqn. (23) is thus similar to Eqn. (15), where variable names Xᵢ and Xⱼ are used instead of variable names X and Y. The first term θᵢₖ(X_{īk}) is the Priors term which enforces constraints on valid vectors, the second term Σ_{j:r}(i,j)−log(1−Xⱼₖ) is a backward inference term, which is a sum over the entailment relations that should occur such that the vector i entails some other vector j, the fourth term Σ_{j:r(j,i)} log Xⱼₖ is a forward inference term which is a sum over the entailment relations that should occur such that the vector i interested in is entailed by some other vector j. The third term

$${\sum }_{j : \overline{r} ( i , j )} log \frac{1 - {C}_{ijk} ( 1 - {X}_{jk} )}{1 - {C}_{ijk}}$$

and the fifth term

$${\sum }_{j : \overline{r} ( j , i )} log \frac{1 - {C}_{ijk}}{1 - {C}_{ijk} {X}_{jk}}$$

reflect the relations that are desired to be not true. The values for Cᵢⱼₖ can either be set using the equation in (21) above, or set to a constant value between 0 and 1, exclusive.

For the negative entailment cases r̅ (terms 3 and 5) it is not in general tractable to explicitely sum over all negative cases for each ik. These can either be treated as a constant, ignored, computed as the total sum minus the positive cases, or computed with negative sampling.

In summary, the mean-field approximation performs inference in entailment graphs by iteratively re-estimating each Xᵢ as the element-wise sigmoid function applied to the sum of: the prior log-odds, −log(1−Xⱼ) for each entailed variable j, and log Xⱼ for each entailing variable j. This inference optimizes Xᵢ [symbol] xⱼ for each entailing j plus Xᵢ [symbol] xⱼ for each entailed j, plus a maximum entropy regularizer on Xᵢ. Negative entailment relations, if they exist, can also be incorporated with some additional approximations. Complex priors can also be incorporated through the prior log-odds, for example using a mean-field approximation of the prior.

### Applications

The inferred vector Y (or X) may be output or can be used to make predictions or perform reasoning.

For example, if Y is the vector which represents the meaning of toy gun, and given the sentence John bought a toy gun, the vector could be used for inferring entailment, e.g., to infer whether John bought a physical object or a digital object, as a function of the probabilities for these two features in Y.

In another embodiment, one or more output vectors may be used in summarization, for identifying a sentence or short text sequence which summarizes a longer text sequence.

Specific applications will now be described.

1. Algorithms for Distributional Semantics: Word2Hyp

Distributional semantics learns the semantics of words by looking at the distribution of contexts in which they occur. It can be assumed that the semantic features of a word are (statistically speaking) redundant with respect to those of its context words, and consistent with those of its context words. For example, the meaning of toy in the phrase plastic toy gun may be assumed to have semantic features similar to those of its left and/or right contexts plastic and gun. In this example, only one context is considered, but the word toy is expected to be found in other contexts in a collection of texts (which may be unlabeled), as in plastic toy weapon, wicked toy guns, and so forth, depending on the type of texts in the collection.

The distribution can be modeled using a hidden semantic vector which is the consistent unification of the vectors for the middle word (toy) and for the contexts in which it is found (such as plastic and gun). In other words, it is assumed that a hidden vector exists which entails both of the middle word vector and the context vectors, and which is consistent with the prior constraints on the vectors. This can be split into two steps, first, inference of the hidden vector from the middle vector, context vectors and prior constraints on the hidden vector, and second, computing the log-probability that this hidden vector entails both the middle vector and the context vectors. This model may be trained so that the resulting log-probability is high for the observed middle word and low for other words, given the observed context, as in the Word2Vec CBOW model of Mikolov 2013a. The word embeddings produced by the model are the vectors assigned to the middle words.

Alternative models of this kind, which differ in the specifics of parameterization, inference approximations and word prediction function, are contemplated and are evaluated in the Examples below. One model useful in unsupervised cases models the middle word according to the inference procedures and the entailment model presented in the Inference in Entailment Graphs method above. Results of experiments validate the assumptions about the relation between context and a word, implying coherence between the prediction of entailment relations in the model and the prediction of entailment relations in hyponymy data.

The context word vectors are modeled as directly adding to the log-odds of the inferred hidden vector. This allows context word vectors to include both the direct features of the word (the −log(1−Xⱼ) terms in Equation 23) which must be non-negative, and the indirect consequences of prior constraints given the word (the θᵢ(Xⱼ) terms in Equation 23) which can be negative. Thus, it not expected that the middle word vectors and the context word vectors will be the same. Modeling more complex non-binary multi-word prior constraints on vectors need not be attempted.

The resulting model infers the hidden probability vector Zᵢ from the middle vector Xᵢ and the context vectors log odds(Yⱼ) as:

$${Z}_{i} = σ ( - log ( 1 - {X}_{i} ) + {\sum }_{j ∈ {C}_{i}} log odds ( {Y}_{j} ) )$$

and similarly for the combined context vector′ᵢ.

$${Y}_{i}^{′} = σ ( {\sum }_{j ∈ {C}_{i}} log odds ( {Y}_{j} ) )$$

The log-probability of both entailments holding is:

log P(zᵢ [symbol] xᵢ, zᵢ [symbol] y′ᵢ)≈Zᵢ [symbol] Xᵢ+Zᵢ [symbol] Y′ᵢ

As in the Word2Vec model, a sigmoid function is applied to this score to make middle word predictions.

P(wᵢ|w_{j∈C}_{ᵢ})≈σ(Zᵢ [symbol] Xᵢ+Zᵢ [symbol] dY′ᵢ)

All other aspects of the model are the same as in the default settings of Word2Vec, including negative sampling of middle words, and re-weighting context vectors inversely to the context size.

This distributional semantic model is referred to herein as the Word2Hyp model, due to its similarity to Word2Vec and the fact that it is designed to be used for hyponymy prediction.

Interpreting Word2Vec Vectors

To evaluate how well the exemplary method provides a formal foundation for the distributional semantics of entailment, it can be used to re-interpret an existing model of distributional semantics in terms of semantic entailment. There has been considerable work on how to use the distribution of contexts in which a word occurs to induce a vector representation of the semantics of words. The previous work on distributional semantics by re-interpreting a previous distributional semantic model and using this understanding to map its vector-space word embeddings to vectors in the exemplary framework. Then the proposed operators are used to predict entailment between words using these vectors. In the examples below, the predictions are evaluated on the task of hyponymy detection.

Three different ways to interpret the Word2Vec distributional semantic model are applied as an approximation to an entailment-based model of the semantic relationship between a word and its context.

Distributional semantics learns the semantics of words by looking at the distribution of contexts in which they occur. To model this relationship, we assume that the semantic features of a word are (statistically speaking) redundant with those of its context words, and consistent with those of its context words. These properties are modeled using a hidden vector which is the consistent unification of the features of the middle word and the context. In other words, there must exist a hidden vector which entails both of these vectors, and is consistent with prior constraints on vectors. This can be split into two steps, inference of the hidden vector Y from the middle vector Xₘ, context vectors X_{c} and prior, and computing the log-probability (23) that this hidden vector entails the middle and context vectors:

$${max}_{Y} ( log P ( y , y ⇒ {x}_{m} , y ⇒ {x}_{c} ) ) \qquad ( 24 )$$

Word2Vec's Skip-Gram model is interpreted as learning its context and middle word vectors so that the log-probability of this entailment is high for the observed context words and low for other (sampled) context words. The word embeddings produced by Word2Vec are only related to the vectors Xₘ assigned to the middle words; context vectors are computed but not output. The context vectors X′_{c} are modeled as combining (information about a context word itself with information which can be inferred from this word given the prior, X′_{c}=θ_{c}−log σ(−X_{c}) where Q(yₖ=1)=σ(θₖ^{y}−log(1−Q(xₖ=1))).

The numbers in the vectors output by Word2Vec are real numbers between negative infinity and infinity, so the simplest interpretation of them is as the log-odds of a feature being known. In this case we can treat these vectors directly as the Xₘ in the model. The inferred hidden vector Y can then be calculated using the model of backward inference from Eqn. (23).

Y=θ_{c}−log σ(−X_{c})−log σ(−Xₘ)=X′_{c}−log σ(−Xₘ)

Word2Vec's Skip-Gram model is interpreted as learning its context and middle word vectors so that the log-probability of this entailment is high for the observed context words and low for other (sampled) context words. The word embeddings produced by Word2Vec are only related to the vectors Xₘ assigned to the middle words; context vectors are computed but not output. The context vectors X′_{c} are modeled as combining (as in equation (23)) information about a context word itself with information which can be inferred from this word given the prior, X′_{c}=θ_{c}−log σ(−X_{c}).

Since the unification Y of context and middle word features is computed using backward inference, the backward-inference operator is used to calculate how successful that unification was. This gives the final score:

log P(y, y [symbol] xₘ, y [symbol] x_{c})≈Y [symbol] Xₘ+Y [symbol] X_{c}+−σ(−Y)·θ_{c}=Y [symbol] Xₘ+−σ(−Y)·X′_{c}

This is a natural interpretation, but it ignores the equivalence in Word2Vec between pairs of positive values and pairs of negative values, due to its use of the dot product. As a more accurate interpretation, each Word2Vec dimension is interpreted as specifying whether its feature is known to be true or known to be false. Translating this Word2Vec vector into a vector in our entailment vector space, one copy Y⁺ of the vector is obtained, representing known-to-be-true features and a second negated duplicate Y⁻ of the vector representing known-to-be-false features, which are concatenated to get representation Y.

Y⁺=X′_{c}−log σ(−Xₘ)

Y⁻=−X′_{c}−log σ(Xₘ)

Log P(y, y [symbol] xₘ, y [symbol] x_{c})≈Y⁺ [symbol] Xₘ+−σ(−Y⁺)·X′_{c}+Y⁻ [symbol] (−Xₘ)+−σ(−Y⁻)·(−X′_{c})

As a third alternative, this latter interpretation can be modified with some probability mass reserved for unknowns in the vicinity of zero. By subtracting 1 from both the original and negated copies of each dimension, a probability of unknown of 1−σ(Xₘ−1)−σ(−Xₘ−1) is obtained. This gives:

Y⁺=X′_{c}−log σ(−(Xₘ−1))

Y⁻=−X′_{c}−log σ(−(−Xₘ−1))

log P(y, y [symbol] xₘ, y [symbol] x_{c})≈Y⁺ [symbol] (Xₘ−1)+−σ(−Y⁺)·X′_{c}+Y⁻ [symbol] (−Xₘ−1))+−σ(−Y⁻)·(−X′_{c})

2. Algorithms for Abstraction Clustering

For applications such as opinion summarization, it is desirable to be able to cluster statements such that each cluster can be labeled with an abstract statement which everything in the cluster entails. Then the labels with their cluster sizes can be used as an abstract summary of the range of opinions. A general algorithm can be used for doing this type of clustering, given vector representations of each element to be clustered, referred to as the K-abstractions algorithm.

In the K-abstractions algorithm, clustering is made tractable by separating the task of finding the clustering from the task of finding the labels. First the clustering is found using an algorithm similar to K-means clustering, which gives both the assignment of elements to clusters and a vector associated with each cluster. Then the best label is found for each cluster's vector. The K-abstractions algorithm can be seen as one example of how to extend a standard clustering algorithm using the entailment operators.

Like K-means, the K-abstractions algorithm alternates between finding K abstract vectors that are each entailed by all the vectors in its cluster and finding clusters that entail each abstract vector. The former step entails application of the forward inference method described above:

$${Y}_{jk} = σ ( {\sum }_{i ∈ {C}_{j}^{F}} log {X}_{ik} )$$

where Cⱼ^{F} is the set of vectors in cluster j.

The latter step entails assigning each vector to the abstract vector which it entails the best:

xᵢ ∈ Cⱼ^{F} iffj=arg maxⱼYⱼ [symbol] Xᵢ

To find the best labeling given a clustering, all the members of each cluster are considered, and the one whose vector is the most similar to the cluster's abstract vector is chosen. In this case, similarity may be defined as the sum of the log-entailment scores in both directions.

lⱼ=arg max_{i∈C}_{ⱼ}_{^{F}}Yⱼ [symbol] dXᵢ+Xᵢ [symbol] dYⱼ

Empirically, the above clustering method can suffer from imbalanced clusters. This happens because one cluster vector becomes more abstract than the others, and then all the vectors choose to be in that cluster. This problem can be addressed by normalizing the cluster vectors to make them all “equally abstract”. This can be achieved by adding an L₁ bound on log Yⱼ. Optimizing the loss within this bound then amounts to dividing the vectors of log-probability sums (inside the sigmoid) by their L₁ norm.

$${Y}_{jk} = σ ( \frac{{\sum }_{i ∈ {C}_{j}^{F}} log {X}_{ik}}{{\sum }_{k} {\sum }_{i ∈ {C}_{j}^{F}} - log {X}_{ik}} )$$

This version results in more balanced cluster sizes. This clustering algorithm illustrates how the exemplary vector-space model of entailment may be useful for summarization.

### Other Applications

Although existing methods often use distributional semantic vectors, they all make use of trained parameters which are not in the vector space itself, and therefore are learning about hyponymy outside the vector space. Such trained models are not readily generalized to other settings, such as using entailment to define a compositional vector-space model or for clustering vectors based on entailment.

By learning a mapping into a vector space which represents entailment, rather than learning an entailment classifier directly as in previous work, the exemplary models generalize naturally to the composition of multi-word expressions and sentences. An example of how such composition can be modeled is given above for the hidden vector of the Word2Hyp distributional semantic model. The composed latent vector could then form the input to another composition, producing a hierarchical compositional structure useful for understanding phrases and sentences. The general graph-structured case of such a compositional model is given above. Such a model could be used to predict textual entailment between sentences and larger pieces of text. Textual entailment is a fundamental task in natural language semantics, and has a wide range of applications.

Two specific applications of the method are summarization and question answering. Summarization is typically done by extracting a subset of the statements in a text, possibly with some rephrasing of the result. With textual entailment it becomes possible to summarize with more abstract statements than those which actually occur in the text. A summary simply needs to be entailed by the text, with the relevance of different information being a separate issue. Answering questions about a document is a similar problem, but relevance is determined by the question. Given a question, the aim is to find the relevant information in the document (or collection of documents), such that the information is entailed by the document(s).

A specific case of summarization which is particularly appropriate for this approach is opinion summarization, where a large collection of texts is provided and the goal is to summarize both the content and distribution of those opinions. Given the present model of entailment and the model of clustering presented above, clusters labeled by a vector that is entailed by the vectors for all the elements in the cluster are obtained. The label vector then forms an abstract representation of the cluster. If the elements are text and the labels are themselves associated with text, then the text label represents an abstract summary of every text in the cluster. Applying this technique to the clustering of opinions gives us a powerful new form of opinion summarization. Such abstract summaries are invaluable in opinion summarization because they are able to summarize a large numbers of opinions, none of which say exactly the same thing, but many of which agree on some points.

In summary, the exemplary vector operators for entailment are based on a mean-field approximation to logical entailment. Derived vector inference algorithms and vector clustering algorithms based on these operators have been described. These methods allow the definition of more powerful models based on distributional semantic vectors than are possible with the semantic similarity measured by the dot product. For example, the clustering algorithm finds center vectors which are an abstraction of all the vectors in the cluster, rather than a centroid, and thus is appropriate for producing abstract summaries of collections of documents.

Without intending to limit the scope of the exemplary embodiment, the following Examples illustrate the application of the method.

### EXAMPLES

It can be shown that the exemplary forward and backward operators can indeed detect entailment in semantic vector spaces. This can be demonstrated by the operators ability to detect lexical entailment in a previously proposed distributional semantic vector space for embedding words. These experiments use data on hyponymy, which is the canonical type of lexical entailment. Initial results on the unsupervised induction of new distributional semantic vector spaces which are designed to work well with the operators are described. Since clustering is an unsupervised method, no attempt is made to quantitatively evaluate the clustering algorithms. The hyponymy results suggest applications of this method will be successful.

Examples using Word2Vec distributional semantic vectors 44 to predict hyponymy relations between words, in both purely unsupervised and semi-supervised settings are described below. Compared to both the dot product and arithmetic differences that have been previously used for studying semantics of Word2Vec vectors, the exemplary operators are better in a variety of settings. The performance of the operators is comparable to that obtained by training a hyponymy classifier in the semi-supervised setting. The operators achieve exceptional results on unsupervised hypernym detection. A clustering method based on these operators, applied to words, is described. Initial results on distributional semantics models (analogous to Word2Vec) are also presented. This approach to the induction of entailment relations is advantageous in that the entailment relations are captured within the vector representations themselves, and thus these models generalize naturally to the compositional case.

In the evaluations below, the experimental setup of Weeds 2014 is employed, using publicly available word embeddings as the vectors 44. The present method achieves better results than Weeds 2014 in both unsupervised and semi-supervised experiments.

For an evaluation on hyponymy classification, the experimental setup of Weeds 2014 is replicated, using their selection of word pairs from the BLESS dataset (Baroni, M., et al., “How we BLESSed distributional semantic evaluation,” Proc. GEMS 2011 Workshop on GEometrical Models of Natural Language Semantics (GEMS '11), pp. 1-10 (2011), “Baroni 2011”). These word pairs include hypernym pairs plus pairs in other semantic relations plus some random pairs. Their selection is balanced between positive and negative examples, so that accuracy can be used as the performance measure. All pairs are noun-noun pairs. For their semi-supervised experiments, ten-fold cross validation is used, where for each testing set, items are removed from the associated training set if they contain any word from the testing set. Thus, the vocabulary of the training and testing sets are always disjoint, thereby requiring that the models learn about the vector space and not about the words themselves. A 10-fold split is performed, but the same procedure as theirs is applied to select the training set.

The word embeddings used in Weeds 2014 could not be replicated so instead publicly available word embeddings are used as the word vectors 44 (https://code.google.com/archive/p/word2vec/). These vectors were trained with the Word2Vec software applied to about 100 billion words of the Google-News dataset, and have 300 dimensions. Since the features in these vectors can be either positive or negative, they are interpreted as log-odds and the entailment operators [symbol] and [symbol] are applied.

Hyponymy classification results are given in Table 2, including both unsupervised (upper half) and semi-supervised (lower half) experiments. Two measures of performance are employed, accuracy (50% Acc) and direction accuracy (Dir Acc). Since all the operators only determine a score, a threshold is chosen to provide accuracies. This threshold is highly dependent on the proportion of positive and negative examples in the dataset, which is a completely artificial proportion and thus not predictable with unsupervised methods. For this reason, each operator's score was threshold at the point where the proportion of positive examples output is 50%, since the gold annotations have the same number of positive and negative examples, which we call “50% accuracy”. Results with two operators [symbol] and [symbol] are compared with those of Weeds 2014, which uses different embeddings and a classifier instead of a vector mapping, as well as the dot product (dot) and vector difference (dif) measures, as well as to the probabilistically-exact calculation of yᵢ [symbol] xᵢ( [symbol] ), where the vector values are interpreted as the log-odds of a feature being true. For the semi-supervised case, training a linear vector-space mapping into a new vector space is compared, in which the operators are applied. Weeds 2014 describes a number of unsupervised and semi-supervised models. The present results use an equivalent testing setup, but use different vector-space embeddings. For the semi-supervised models, Weeds 2014 trains classifiers.

TABLE 2
Accuracies on the Bless data from Weeds 2014, using the
Google-News word embeddings, for hyponymy classification
(50% Acc) and hyponymy direction classification (Dir Acc),
in unsupervised and semi-supervised experiments.

| operator | supervision | 50% Acc | Dir Acc |
|---|---|---|---|
| Weeds et. al. | None | 58% | — |
| Log odds [symbol] | None | 54.0% | 55.9% |
| Log odds [symbol] | None | 60.1% | 62.2% |
| Weighted cos | None | 55.5% | 57.9% |
| dot | None | 56.3% | 50% |
| dif | None | 56.9% | 59.6% |
| Log odds [symbol] | None | 57.0% | 59.4% |
| dup [symbol] | None | 61.7% | 68.8% |
| unk dup [symbol] | None | 63.4%* | 68.8% |
| unk dup [symbol] | None | 64.5% | 68.8% |

Semi-Supervised

| | | | |
|---|---|---|---|
| Weeds 2014 | SVM | 75% | — |
| mapped dif | Cross entropy | 64.3% | 72.3% |
| mapped [symbol] | Cross entropy | 77.5% | 92.3% |
| mapped [symbol] | Cross entropy | 74.5% | 91.0% |
| mapped [symbol] | Cross entropy | 80.1% | 90.0% |

Direction accuracy indicates how well the method distinguishes the relative abstractness of two nouns. Given a pair of nouns which are in a hyponymy relation, it classifies which word is the hypernym and which is the hyponym. This measure only considers positive examples and chooses one of two directions, so it is inherently a balanced binary classification task. Classification is performed by simply comparing the scores in both directions. If both directions produce the same score, the expected random accuracy (0.5) is used.

Unsupervised Hypernym Detection and Direction Classification: The first set of experiments evaluate the present vector-space operators in unsupervised models of hypernym detection. Because Word2Vec vector values can be any real number, they can be interpreted as log-odds and the [symbol] and [symbol] operators applied. These are compared to the dot product (dot), because this is the standard vector-space operator and has been shown to capture semantic similarity very well. However, because the dot product is a symmetric operator, it always performs at chance for direction classification. Another vector-space operator which has received much attention recently is vector differences (dif). This is used (with vector sum) to perform semantic transforms, such as the sum “king−male+female=queen”, and has previously been used for modeling hyponymy (Vylomova 2015, Weeds 2014). For the present case, the pairwise differences are summed to get a score which is used for hyponymy classification. The weighted cosine (Marek Rei, et al., “Looking for Hyponyms in Vector Space,” Proc. 18^{th} Conf. on Computational Natural Language Learning, pp. 68-77, 2014) (weighted cos), was also compared. All methods were computed with the same word embeddings as for the exemplary operators.

The three progressively more accurate interpretations of Word2Vec vectors described above, namely the log-odds interpretation (log-odds [symbol] ), the negated duplicate interpretation (dup [symbol] ), and the negated duplicate interpretation with unknown around zero (unk [symbol] ) were also evaluated. Also, the factorized calculation of entailment (log-odds [symbol] , unk dup [symbol] ), and the backward-inference entailment operator (log-odds [symbol] ), were also evaluated. For the semi-supervised case, a linear vector-space mapping into a new vector space is learned, in which the operators (mapped operators) are applied. All these results are discussed in the next two subsections.

Results on Hyponymy Detection with Word2Vec Vectors

For the unsupervised results in the top half of Table 2, the unsupervised model of Weeds 2014, and the operators dot, dif, and weighted cos all perform similarly on accuracy, as does the log-odds factorized entailment calculation (log-odds [symbol] ). The forward-inference entailment operator (log-odds [symbol] performs above chance but not well, as expected given the backward-inference-based interpretation of Word2Vec vectors. By definition, dot is at chance for direction classification, but the other models all perform better, indicating that all these operators are able to measure relative abstractness. The [symbol] operator, which is most sensitive to negative log-odds values, performs the worst on accuracy in these experiments. But the [symbol] operator, which is most sensitive to positive log-odds values, performs the best on both accuracy and direction accuracy.

The more accurate interpretation of Word2Vec vectors specifying both original and negated features (dup [symbol] ) provides a marginal improvement (on the log-odds interpretation). The third and most accurate interpretation, where values around zero can be unknown (unk dup [symbol] ), achieves the best results in unsupervised hyponymy detection, as well as for direction classification. Changing to the factorized entailment operator (unk dup [symbol] ) is worse but also significantly better than the other accuracies.

To allow a direct comparison to the model of Vilnis (Luke Vilnis et al., “Word representations via Gaussian embedding,” Proc. Int'l Conf. on Learning Representations (ICLR) 2015), the unsupervised models were also evaluated on the hyponymy data from Marco Baroni, et al., “How we blessed distributional semantic evaluation,” Proc. of the GEMS 2011 Workshop on Geometrical Models of Natural Language Semantic, (GEMS), pp. 1-10, 2011. The best model achieved 81% average precision on this dataset, compared to the 80% achieved by the best model of Vilnis.

### Semi-Supervised Hypernym Detection and Direction Classification

Since the unsupervised learning model may be considering many factors which have nothing to do with hyponymy, we also consider a semi-supervised setting. Adding some supervision helps distinguish features that capture semantic properties from other features which are not relevant to hypernym detection. But even with supervision, the aim of the present method is for the resulting model to be captured in a vector space, and not in a parametrized scoring function. Thus, mappings are trained from the Word2Vec word vectors to new word vectors, and then the entailment operators applied in this new vector space to predict hyponymy. Because the words in the testing set are always disjoint from the words in the training set, this experiment measures how well the original unsupervised vector space captures features that generalize entailment across words, and not how well the mapping can learn about individual words. For this reason, this is referred to as a semi-supervised setting, rather than a supervised setting.

The objective is to learn a mapping to a new vector space in which an operator can be applied to predict hyponymy. Linear mappings are trained for the [symbol] operator (mapped [symbol] ) and for vector differences(mapped dif). Previous work on using vector differences for semi-supervised hyponymy classification has used a linear SVM (Vylomova 2015, Weeds 2014), which is mathematically equivalent to the vector-differences model, except that cross entropy loss is used here rather than a large-margin loss and SVM training. Using large-margin loss in the present training regime could alternatively be performed.

The semi-supervised results in the lower half of Table 2 show a similar pattern to the unsupervised results. The [symbol] operator achieves in the best generalization from the mapping for training words to the mapping for testing words. The mapped [symbol] model has the highest accuracy, followed by the probabilistic entailment operator [symbol] and Weeds 2014, which have similar accuracies. Direction accuracy of mapped [symbol] reaches 91%, much better than with vector differences dif and similarly to probabilistic entailment. The dif operator performs particularly poorly in this mapped setting, perhaps because both the mapping and the operator are linear.

### 4.2 Results on Hypernym Detection for Word2Hyp Vectors

To evaluate the Word2Hyp distributional semantic model, the above experiments were repeated using word embedding vectors which were trained on a corpus of half a billion words of Wikipedia. As a baseline, the CBOW model of the Word2Vec software (Mikolov 2013a, Mikolov 2013b) was trained with 200 dimensions and default settings. Table 3 shows the results obtained. The Word2Hyp model uses the objective function described above. Development of the Word2Hyp model was done using a different experimental setup and only unsupervised experiments. Again, 50% Acc classification thresholds are set to output 50% positives.

TABLE 3
Accuracies on the Bless data from Weeds 2014, using embeddings
trained on half a billion words of Wikipedia, for hyponymy classification
(50% Acc) and hyponymy direction classification (Dir Acc), in
unsupervised and semi-supervised experiments.

| embeddings | operator | supervision | 50% Acc | Dir Acc |
|---|---|---|---|---|
| Word2Vec | [symbol] | None | 50.2% | 46.6% |
| Word2Hyp | [symbol] | None | 61.1% | 65.0% |
| Word2Vec | Dot | None | 52.7% | 50% |
| Word2Vec | Dif | None | 48.7% | 44.0% |
| Word2Vec | mapped [symbol] | cross entropy | 84.4% | 95.3% |
| Word2Hyp | mapped [symbol] | cross entropy | 82.2% | 92.1% |
| Word2Vec | mapped dot | cross entropy | 52.7% | 50% |
| Word2Vec | mapped dif | cross entropy | 56.0% | 60.1% |

Trained on this smaller corpus, the unsupervised models did not generally perform as well as in Table 2. For the unsupervised results, the Word2Hyp vectors perform better than the Word2Vec vectors when used with the [symbol] operator. The Word2Hyp [symbol] results are better than the [symbol] results with Google-News embeddings in Table 2, despite the apparent disadvantage of the smaller training corpus. For the semi-supervised experiments, the results are very different from the unsupervised results. Both the Word2Vec [symbol] and the Word2Hyp [symbol] models perform surprisingly well, better than all the results in Table 2. In this experiment, the Word2Vec [symbol] model performs better than the Word2Hyp [symbol] model, on both accuracy and direction accuracy.

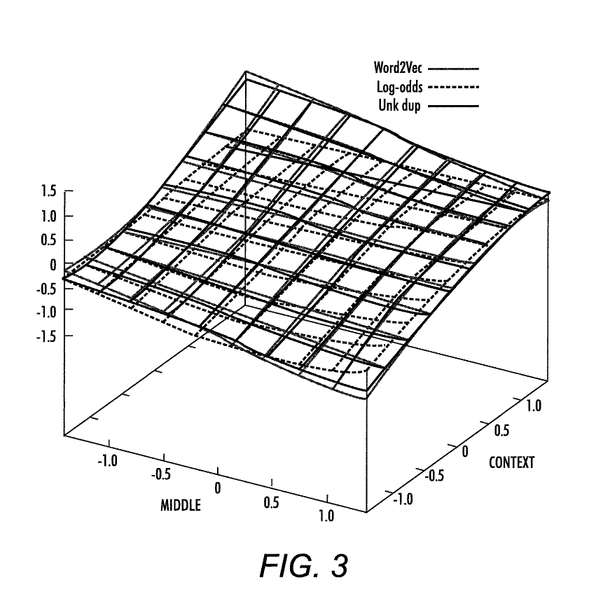

To understand better the relative accuracy of these three interpretations, the training gradient which Word2Vec uses to train its middle-word vectors was compared to the training gradient for each of these interpretations. These gradients were plotted for the range of values typically found in Word2Vec vectors for both the middle vector and the context vector. FIG. 3 shows three of these plots. As expected, the second interpretation is more accurate than the first because its plot is anti-symmetric around the diagonal, like the Word2Vec gradient. In the third alternative, the constant 1 was chosen to optimise this match, producing a close match to the Word2Vec training gradient, as shown in FIG. 3 (Word2Vec versus Unk dup).

Thus, Word2Vec can be seen as a good approximation to the third model, and a progressively worse approximation to the second and first models. Therefore, the best accuracy in hyponymy detection would be expected using the third interpretation of Word2Vec vectors.

The results demonstrate the usefulness of the entailment operators for predicting semantic entailment based on detection of hyponymy between words in a distributional semantic vector space. The distributional semantic model provides a mapping from words to vectors, which can then be used to predict lexical entailment between two words using the operators. The unsupervised model has been evaluated on hyponymy classification, and on classifying the direction of a given hyponymy pair. These experiments indicate that these operators do reflect information discovered by distributional semantics about both the similarity and relative abstractness necessary to detect hyponymy, showing better performance than both dot product and vector differences. To further demonstrate usefulness, the operators are evaluated in a semi-supervised setting, where mappings from the unsupervised vector space to a new vector space are learnt in which the entailment operator makes more accurate hyponymy predictions. These experiments show that the entailment operators are powerful enough to capture hyponymy in a trained vector space, and simple enough that the mapping from the unsupervised vectors generalizes to words which were not in the training set.

By learning a mapping into a vector space which represents entailment, rather than learning an entailment classifier directly as in previous work, these models generalize naturally to the composition of multi-word expressions and sentences. Such a model can be used to predict textual entailment between sentences and texts. This is particularly useful for question answering and opinion summarization.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for making an entailment inference, comprising:
with a processor, computing an entailment inference for a first text object with respect to a second text object, comprising computing a function of semantic representations of the first and second text objects with an asymmetric vector space operator; and
outputting information based on the inference.

2. The method of claim 1, further comprising generating at least one of the semantic representations with a semantic model trained on training text sequences labeled with entailment relations.

3. The method of claim 2, further comprising training the semantic model with the labeled training text sequences.

4. The method of claim 1, wherein the first and second text objects are extracted from an input text sequence.

5. The method of claim 1, wherein the asymmetric vector space operator is selected from:
a forward-inference entailment operator for predicting whether the first text object, having a semantic representation X is entailed by the second text object, having a semantic representation Y as a function of a dot product of X and log Y, where log Y is a vector in which each element is the logₑ of the corresponding element in Y;
a backward-inference entailment operator for predicting whether the second text object entails the first text object as a function of a dot product of (1−Y) and log(1−X); and
a factorized entailment operator for predicting whether an entailment relationship exists from the text object having the semantic representation Y to the text object having the semantic representation X.

6. The method of claim 5, wherein the factorized entailment operator is parameterized according to:
Y [symbol] X=Σₖ log(1−σ(−Yₖ)σ(Xₖ)),
where σ represents the sigmoid function and Yₖ and Xₖ are the kth elements of semantic representations Y and X, respectively.

7. The method of claim 1, wherein the making of the entailment inference comprises modeling a probability of entailment using a mean-field approximation.

8. The method of claim 1, wherein the inference comprises inferring at least one of:
whether the first text object entails the second text object;
whether the second text object entails the first text object;
a semantic representation of the second text object, given that an entailment relation exists between the first and second text objects; and
a semantic representation of the first text object, given that an entailment relation exists between the first and second text objects.

9. The method of claim 1, wherein constraints on the non-independence of elements of the semantic representations are enforced by the function.

10. The method of claim 9, wherein the constraints are incorporated in a constraint vector for predicting one of:
the semantic representation X of the first text object according to:
X=σ(θ^{x}+log Y), and
the semantic representation Y of the second text object according to:
Y=σ(θ^{y}+−log(1−X)),
where represents a sigmoid function which outputs a value between 0 and 1, θ^{x} and θ^{y} are the constraint vectors which represent prior information about elements x and y of vectors X and Y, respectively.

11. The method of claim 1, further comprising parametrizing the first and second representations by their log-odds.

12. The method of claim 1, wherein the asymmetric vector space operator is selected from:
a forward-inference entailment operator for predicting whether the first text object, having a semantic representation X is entailed by the second text object, having a semantic representation Y as a function of:
a dot product of X and log Y, where log Y is a vector in which each element is the logₑ of the corresponding element in Y, or
a dot product of σX and log σY, where log σY is a vector in which each element is the logₑ of the application of σ to the corresponding element in Y and σ represents the sigmoid function;
a backward-inference entailment operator for predicting whether the second text object entails the first text object as a function of:
a dot product of (1−Y) and log(1−X), or
a dot product of σ(−Y) and log σ(−X); and
a factorized entailment operator for predicting whether the second text object entails the first text object as a function of a sum, over a set of k dimensions, of a log function of the kth elements of X and Y.

13. The method of claim 1, wherein each of the semantic representations comprises a multidimensional vector, each dimension of the multidimensional vector represents whether something that is knowable about the text object is known or unknown.

14. The method of claim 1, further comprising clustering semantic representations of a set of text objects, based on the inferences.

15. A computer program product comprising a non-transitory recording medium storing instructions, which when executed on a computer, causes the computer to perform the method of claim 1.

16. A system comprising memory which stores instructions for performing the method of claim 1 and a processor in communication with the memory for executing the instructions.

17. An entailment system comprising:
a representation generation component which generates semantic representations of text objects using a trained semantic model, each semantic representation comprising a multidimensional vector;
an inference component which computes an entailment inference for a first text object with respect to a second text object, comprising computing a function of semantic representations of the first and second text objects with an asymmetric vector space operator;
an output component which outputs information based on the inference; and
a processor which implements the components.

18. The entailment system of claim 17, further comprising:
a learning component which learns the semantic model using labeled training data.

19. The entailment system of claim 17, further comprising:
a clustering component which clusters semantic representations of a set of text objects, based on the inferences.

20. A method for making an entailment inference, comprising:
storing an asymmetric vector space operator for computing a function of semantic representations of first and second text objects, the asymmetric vector space operator being selected from:
a forward-inference entailment operator for predicting whether the first text object, having a semantic representation X is entailed by the second text object, having a semantic representation Y as a function of a dot product of X and log Y, or sigmoid functions thereof, where log Y is a vector in which each element is the logₑ of the corresponding element in Y;
a backward-inference entailment operator for predicting whether the second text object entails the first text object as a function of a dot product of (1−Y) and log(1−X), or sigmoid functions thereof; and
a factorized entailment operator for predicting whether the second text object entails the first text object as a function of a sum, over a set of k dimensions, of a log function of the kth elements of X and Y;
with a processor, computing the selected asymmetric vector space operator to infer at least one of:
whether the first text object entails the second text object,
whether the second text object entails the first text object,
a semantic representation of the second text object, given that an entailment relation exists between the first and second text objects;
a semantic representation of the first text object, given that an entailment relation exists between the first and second text objects; and
outputting information based on the inference.

21. The method of claim 20,
wherein the forward-inference entailment operator is of the form:
X [symbol] Y=X·log Y, or
X [symbol] Y≡σ(X)·log σ(Y); and
wherein the backward-inference entailment operator is of the form:
Y [symbol] X=(1−Y)·log(1−X), or
Y [symbol] X≡σ(−Y)·log σ(−X), or
is a factorized entailment operator of the form:
$$Y X ≡ {\sum }_{k} log ( 1 - ( 1 - {Y}_{k} ) ( {X}_{k} ) ) , or$$
$$Y X ≡ {\sum }_{k} log ( 1 - σ ( - {Y}_{k} ) σ ( {X}_{k} ) ) .$$
